(19) United States
(12) Patent Application Publication
(10) Pub. No.: US 2006/0050230 A1
(43) Pub. Date: Mar. 9, 2006

(54) Tinted contact lenses with hatch patterns

(76) Inventors: Jack W. Bowers, Jacksonville, FL (US); Jerry W. Dukes, Jacksonville, FL (US); Karin D. McCarthy, Ponte Vedra Beach, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/922,671

(22) Filed: Aug. 19, 2004

(51) Int. Cl. G02C 7/04

(52) U.S. Cl. 351/162

(57) ABSTRACT

The invention provides tinted contact lenses that include hatch marks that serve to enhance or alter the appearance of the wearer's iris. The lens may also incorporates additional elements that overlie a portion of the wearer's iris or limbus.

### FIELD OF THE INVENTION

The invention relates to tinted contact lenses. In particular, the invention provides contact lenses that either enhance or change the color of a lens wearer's iris.

### BACKGROUND OF THE INVENTION

The use of tinted, or colored, contact lenses to either or both alter the natural color of the iris and to mask ophthalmic abnormalities is well known. Typically, these lenses use either or both opaque and translucent colors to change the color of an iris, as for example, from brown to blue. Additionally, tinted lenses have been manufactured that attempt to enhance the color of a dark-eyed person without changing the color of the iris. These lenses are disadvantageous because either the color enhancement is too subtle to be noticed when the lens is on-eye or the enhancement lends an unnatural appearance to the wearer's iris.

### BRIEF DESCRIPTION OF THE DRAWINGS

FIG. 1 is one embodiment of the invention.

FIG. 2 is a second embodiment of the invention.

FIG. 2a is a magnified view of a portion of the embodiment of FIG. 2.

FIG. 3 is a third embodiment of the invention.

FIG. 4 is a fourth embodiment of the invention.

### DETAILED DESCRIPTION OF THE INVENTION AND PREFERRED EMBODIMENTS

The invention provides tinted contact lenses, and methods for their manufacture, that enhance the lens wearer's iris. The lenses of the invention have a pattern made of hatch marks that serves to enhance the definition of the wearer's iris resulting in the iris appearing larger to viewer's of the lens wearer. Additionally, the lenses of the invention have additional pattern elements that completely or, preferably, partially overlie the wearer's iris. The lenses of the invention may find greatest utility as cosmetic lenses for enhancing a dark-eyed individual's iris, but also may be used to enhance the iris of a light-eyed lens wearer as well.

In one embodiment, the invention provides a contact lens comprising, consisting essentially of, and consisting of a plurality of hatch marks.

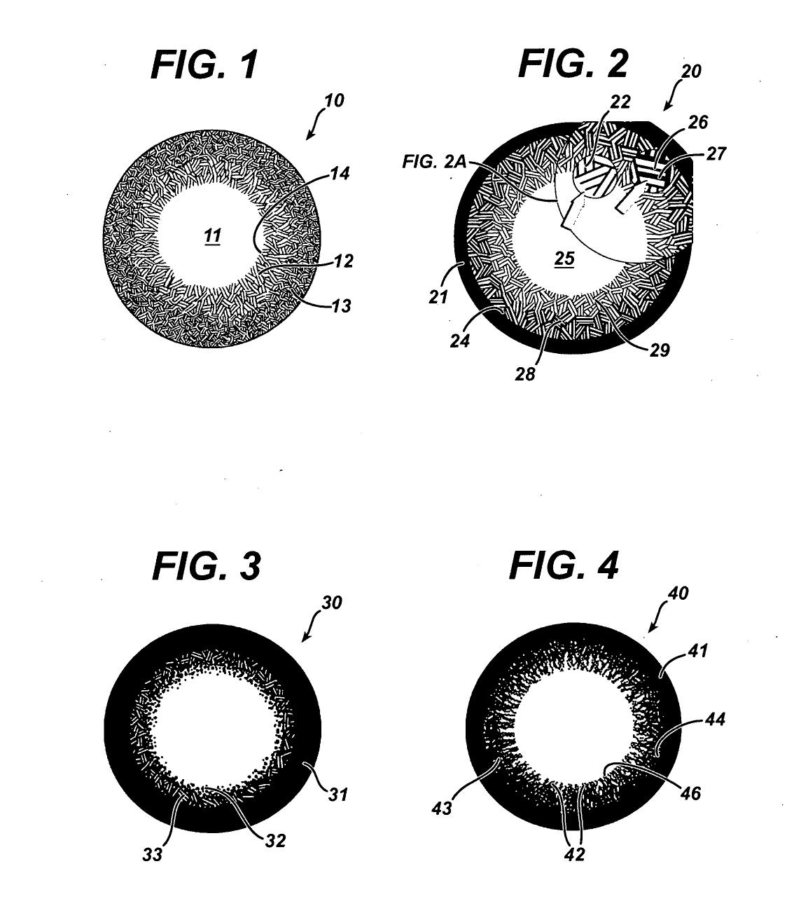

In FIG. 1 is shown one embodiment of a hatch mark pattern 10. In this embodiment, a plurality of randomly arranged hatch marks are shown in a first area 12 and a second area 13. Areas 12 and 13 combined substantially compose the iris portion of the lens. The innermost border 14 of the pattern is at a diameter of about 7 mm from the geometric center of the lens.

By “iris portion” is meant the portion of the lens that overlies the iris when the lens is on-eye and centered. By “hatch mark” is meant a grouping of two or more parallel lines. Each line within the hatch mark preferably is a substantially straight line, but may be non-straight. The hatch marks may, but preferably do not, cover the entire iris portion of the lens. Preferably, the hatch marks extend inwardly from the periphery of the pattern innermost so that the innermost border of the hatch marks is located at about 6.5 mm or more, preferably about 7 mm or more, from the geometric center of the lens. The individual lines that make up the hatch marks may be of uniform or varying widths, lengths and spacing within the hatch mark or in comparison to one or more other hatch marks of which the pattern is composed. Preferably, the individual lines within the hatch marks are about 0.2 to about 1.5 mm in length.

As shown in FIG. 1, area 11 is a region in which there are no pattern elements. Depending on the location of the innermost border 14 of the hatch marks, area 11 may partially compose the iris portion as well as the whole of the pupil portion, or portion of the lens that overlies the wearer's pupil while the lens is on-eye and centered. As shown, area 11 is clear, but it may be translucently or opaquely colored as well. Innermost border 14 as shown is of an even, regular shape, but may be an uneven, irregular border.

By comparing the hatch marks of areas 12 with those of area 13, one can observe that the lengths and spacing of the individual lines within the areas differ. For example, the lines of the hatch marks in area 12 are longer than the hatch marks of area 13.

The hatch marks of the patterns of the invention may be combined with any number of additional elements. Such components may include, without limitation, limbal rings, geometric structures, such as dots and lines, or fanciful structures including, without limitation striae or feather-like structures. In one preferred embodiment, the hatch marks are combined with a limbal ring and the invention provides a contact lens comprising, consisting essentially of, and consisting of a limbal ring and a plurality of hatch marks.

By “limbal ring” is meant an annular band of color that, when the lens is on-eye and centered, partially or substantially completely overlies the lens wearer's limbal region, or the junction of the sclera with the cornea. Preferably, the limbal ring substantially completely overlies the limbal region. The innermost border, or edge closest to the geometric center of the lens, of the limbal ring may be at a diameter of about 8 mm to about 12 mm, preferably about 9 to about 11 mm, from the lens' geometric center. The ring may be of any suitable width and preferably is about 0.5 to about 2.5 mm in width, more preferably about 0.75 to about 1.25 mm in width.

Preferably, and as show in FIG. 2, beginning at the innermost border of the limbal ring 21 are a plurality of hatch marks extending inwardly toward the geometric center of the lens. Limbal ring 21 is a black opaque band approximately 1 mm in width. A plurality of randomly arranged hatch marks substantially compose the iris portion of the lens, which hatch marks begin at the innermost border 24 of limbal ring 21. Area 25 is a region in which there are no pattern elements, which area will partially compose the iris portion as well as the pupil portion.

As shown in FIG. 2a, lines 22 forming certain of the hatch marks are of the same width. However, lines 26 and 27 forming other of the hatch marks are of differing widths. The effect of either or both the use more closely spaced lines and lines of varying thicknesses is to darken that area of the pattern formed by the hatch marks. This effect is illustrated in FIG. 2 in which area 28 covered by hatch marks composed of lines 26 and 27 appears darker than area 29.

The hatch marks preferably are randomly arranged so that their directions vary. However, the hatch marks may be arranged so that they lie in substantially the same direction, which provides a fibrous texture to the pattern.

In an alternative embodiment and as shown in FIG. 3, hatch marks 33 and a limbal ring 31 are provided along with a plurality of random dots 32 that overlay the hatch marks 33. As shown the random dots 32 extend farther inward toward the center of the lens than do the hatch marks. However, the dots may overlie only the hatch marks. As yet another alternative, the dots may overlay only a portion of the harch marks, such as overlaying only their innermost portions or portions closest to limbal ring 31 or about 1 to about 90% of that area. As yet another alternative, the random dot pattern may be such that, as one moves inwardly toward the lens' geometric center, the dots become less numerous forming a dot density gradient. The dots may be of any size and preferably are about 0.060 to about 0.180 mm in diameter, more preferably about 0.0075 to about 0.0125 mm in diameter.

As yet another alternative, in FIG. 4 is shown the hatch marks combined with both a limbal ring and dots formed into a fibrous dot pattern. By “fibrous dot pattern” is meant a pattern of dots that are arranged such that they appear to form a plurality of fibrous structures in which each of the individual fibrous structures may or may not be intertwined with other of the fibrous structures. In FIG. 4, at the innermost border 44 of limbal ring 41 and extending inwardly towards the geometric center of the lens is fibrous dot pattern 42 composed of a plurality of substantially intertwined fibrous structures. The innermost border 46 of fibrous dot pattern 42 lies at a diameter of about 7 mm from the geometric center of the lens. Innermost borders 46 is shown as an even, regular borders and innermost border 44 is shown as an uneven and irregularly shaped, but either border may be even or uneven in shape. Hatch marks 43 overlay a part of fibrous dot pattern 42 and provide a blending of the border between limbal ring 41 and fibrous dot pattern 42. Preferably, the hatch marks extends over or overlie about 1 to about 90%, preferably about 25 to about 75%, of the fibrous dot pattern.

In any of the patterns of the invention, the pupil portion preferably is clear. However, the pupil portion may be an area of translucent or opaque color or any combination of opaque and translucent colors.

As used in a lens for either enhancing or altering the wearer's eye color, preferably the limbal ring element is a solid band of color that masks the color of the lens wearer's limbal region and more preferably the masking color is an opaque color. The remaining elements, the hath marks, dots and other pattern elements, may be translucent or opaque depending on the desired on-eye result. For purposes of the invention, by “translucent” is meant a color that permits an average light transmittance (% T) in the 380 to 780 nm range of about 60 to about 99%, preferably about 65 to about 85% T. By “opaque” is meant a color that permits an average light transmittance (% T) in the 380 to 780 nm range of 0 to about 55, preferably 7 to about 50% T.

The color selected for each of the hatch marks, limbal ring and remaining pattern elements will be determined by the natural color of the lens wearer's iris and the enhancement or color change desired. Each of the hatch marks, limbal rings and additional elements may be of the same or of complementary colors. Thus, elements may be any color including, without limitation, any of a variety of hues and chromas of blue, green, gray, brown, black yellow, red, or combinations thereof. Preferred colors for the limbal ring include, without limitation, any of the various hues and chromas of black, brown and gray.

The elements, may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange # 1, and the like and combinations thereof Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a pre-polymer, or binding polymer, and a solvent to form the colorant used to produce the translucent and opaque layers used in the lenses of the invention. Other additives useful in contact lens colorants also may be used. The binding polymers, solvents, and other additives useful in the color layers of the invention are known and either commercially available or methods for their making are known.

The elements may be applied to, or printed on, one or more surfaces of a lens or may be printed onto one or more surfaces of a mold into which a lens forming material will be deposited and cured. In a preferred method for forming lenses incorporating the designs of the invention, a thermoplastic optical mold, made from any suitable material including, without limitation, cyclic polyolefins and polyolefins such as polypropylene or polystyrene resin is used. The elements are deposited onto the desired portion of the molding surface of the mold. By “molding surface” is meant the surface of a mold or mold half used to form a surface of a lens. Preferably, the deposition is carried out by pad printing as follows.

A metal plate, preferably made from steel and more preferably from stainless steel, is covered with a photo resist material that is capable of becoming water insoluble once cured. The elements are selected or designed and then reduced to the desired size using any of a number of techniques such as photographic techniques, placed over the metal plate, and the photo resist material is cured.

The plate is subsequently washed with an aqueous solution and the resulting image is etched into the plate to a suitable depth, for example about 20 microns. A colorant containing a binding polymer, solvent, and pigment or dye is then deposited onto the elements to fill the depressions with colorant. A silicon pad of a geometry suitable for use in printing on the surface and varying hardness, generally about 1 to about 10, is pressed against the image on the plate to remove the colorant and the colorant is then dried slightly by evaporation of the solvent. The pad is then pressed against the molding surface of an optical mold. The mold is degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

In a preferred embodiment, a clear, pre-polymer layer is used, which pre-polymer layer overlays at least the limbal ring and dot patterns and preferably forms the entirety of the lens' outermost surface. The pre-polymer may be any polymer that is capable of dispersing the pigment and any opacifying agent used.

The invention may be used to provide tinted hard or soft contact lenses made of any known lens-forming material, or material suitable for manufacturing such lenses. Preferably, the lenses of the invention are soft contact lenses, the lens material selected for forming the lenses of the invention being any material suitable for producing soft contact lenses. Suitable preferred materials for forming soft contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the lens material contains a siloxane functionality, including, without limitation, polydimethyl siloxane macromers, methacryloxypropyl polyalkyl siloxanes, and mixtures thereof, a silicone hydrogel, or a hydrogel, made of monomers containing hydroxy groups, carboxyl groups, or both or and combinations thereof. Materials for making soft contact lenses are well known and commercially available. Preferably, the material is acquafilcon, etafilcon, genfilcon, lenefilcon, balafilcon, lotrafilcon, or galyfilcon.

What is claimed is:

1. A contact lens, comprising a plurality of hatch marks.

2. The contact lens of claim 1, further comprising a limbal ring.

3. The lens of claim 1, wherein one or more of the plurality of the hatch marks comprise individuals lines of a length different from at least one of the other plurality of hatch marks.

4. The lens of claim 2, wherein one or more of the plurality of the hatch marks comprise individual lines of a length different from at least one of the other plurality of hatch marks.

5. The lens of claim 1, wherein one or more of the plurality of the hatch marks comprise individual lines of a width different from at least one of the other plurality of hatch marks.

6. The lens of claim 2, wherein one or more of the plurality of the hatch marks comprise individual lines of a width different from at least one of the other plurality of hatch marks.

7. The lens of claim 1, wherein one or more of the plurality of the hatch marks comprise individual lines of a spacing different from at least one of the other plurality of hatch marks.

8. The lens of claim 1, wherein the plurality of hatch marks comprise a first area and a second area, wherein the individual lines of the hatch marks of the first area are of on or more of a different width, a different length, and a different spacing from the individual lines of the hatch marks of the second area.

9. The lens of claim 2, wherein the plurality of hatch marks comprise a first area and a second area, wherein the individual lines of the hatch marks of the first area are of on or more of a different width, a different length, and a different spacing from the individual lines of the hatch marks of the second area.

10. The lens of claim 1, further comprising one or more of dots, lines, or fanciful structures.

11. The lens of claim 2, further comprising one or more of dots, fines, or fanciful structures.

12. The lens of claim 1, further comprising a fibrous dot pattern.

13. The lens of claim 2, further comprising a fibrous dot pattern.

14. A method of enhancing an iris, comprising providing a contact lens comprising a limbal ring and a plurality of hatch marks.

15. A method of enhancing an iris, comprising providing a contact lens comprising a plurality of hatch marks.
